(19) United States
(12) Patent Application Publication
(10) Pub. No.: US 2026/0344971 A1
(43) Pub. Date: Nov. 5, 2026

(54) HINGE AND DISHWASHER

(71) Applicant: Whirlpool (China) Co., Ltd., Hefei (CN)

(72) Inventors: Penghe Li, Hefei (CN); Javen Jiang, Hefei (CN)

(73) Assignee: Whirlpool (China) Co., Ltd., Hefei, AH (CN)

(21) Appl. No.: 19/663,497

(22) Filed: Apr. 30, 2026

(30) Foreign Application Priority Data
Apr. 30, 2025 (CN) 202520867993.6

(51) Int. Cl. A47L 15/42; E05D 11/10; E05F 1/10

(52) U.S. Cl. CPC A47L 15/4261; E05D 11/1028; E05F 1/1041; E05Y 2900/304

(57) ABSTRACT

A hinge for a dishwasher appliance includes a bracket, a hinge arm rotatably coupled to the bracket, a connecting rod rotatably coupled to the hinge arm, an elastic retainer coupled to the bracket and selectively engaged with the connecting rod, and an elastic element coupled to the bracket and coupled via a flexible member to the connecting rod, wherein the elastic element biases the hinge arm towards the bracket, and when the connecting rod is engaged with the elastic retainer, the elastic retainer biases the hinge arm against the bias of the elastic element away from the bracket to define an intermediate state of the hinge.

### CROSS REFERENCE TO RELATED APPLICATION

This application claims priority to Chinese Utility Model Application No. 202520867993.6, filed Apr. 30, 2025, entitled A HINGE AND DISHWASHER, the entire disclosure of which is hereby incorporated by reference.

### TECHNICAL FIELD

This utility model relates to the field of home appliance technology, and in particular to a hinge for a dishwasher.

### BACKGROUND

Hinges are components that connect the doors and cabinets of household appliances. They enable the doors of appliances to open and close smoothly and ensure the airtightness of the interior space when the appliance is operating. Household appliances may include dishwashers, ovens, microwave ovens, and steam ovens.

In the prior art, the hinge adopts a sliding hinge structure, which allows the door to slide along a certain track when it is opened. It includes a slide rail, a rotating part and an elastic element. However, after a period of use, the hovering function of the rotating part, the slide rail and the elastic element will deteriorate. For example, the friction will increase, resulting in a greater force to open and close the door. At the same time, the elastic element will experience fatigue wear, resulting in an imbalance of force when the hinge is opened and closed, which will affect the normal use of the door.

### SUMMARY

According to one aspect of the present disclosure, a hinge for a dishwasher appliance includes, a bracket, a hinge rotatably coupled to the bracket, a connecting rod rotatably coupled to the hinge arm, an elastic retainer coupled to the bracket and selectively engaged with the connecting rod, and an elastic element coupled to the bracket and coupled via a flexible member to the connecting rod, wherein the elastic element biases the hinge arm towards the bracket, and when the connecting rod is engaged with the elastic retainer, the elastic retainer biases the hinge arm against the bias of the elastic element away from the bracket.

According to another aspect of the present disclosure, a hinge for a dishwasher appliance includes a bracket, a hinge arm rotatably coupled to the bracket, a connecting rod rotatably coupled to the hinge arm and interfaced with the bracket, and an elastic element coupled to the bracket and coupled via a flexible member to the connecting rod, wherein the elastic element biases the hinge arm towards the bracket, wherein during operation of the hinge, a rotational movement of the hinge arm relative to the bracket causes the connecting rod to slide through a guide strip that extends outwards from the bracket and that defines a trajectory about which movement of the connecting rod is limited.

According to another aspect of the present disclosure, a dishwasher appliance includes a dishwasher body forming a washing chamber configured to hold dishware during an operation of the dishwasher appliance, a door connected to the dishwasher body and operable to selectively seal the washing chamber, and a hinge coupled to the dishwasher and the door, wherein the hinge includes a bracket attached to the dishwasher body, a hinge arm rotatably coupled to the bracket and attached to the door, a connecting rod rotatably coupled to the hinge arm, an elastic retainer coupled to the bracket and selectively engaged with the connecting rod and an elastic element coupled to the bracket and coupled via a flexible member to the connecting rod, wherein a bias of the elastic element acts in opposition to both a force of gravity acting on the door and a bias of the elastic retainer to define an intermediate state of the hinge, wherein when the hinge defines the intermediate state, the hinge arm and the door are suspended in a partially open state relative to the dishwasher body, to allow for drying of the dishware disposed within the washing chamber.

The present disclosure can provide several advantages, including, but not limited to the following. By providing a hinge able to provide a drying functionality to a dishwasher appliance, the energy efficiency and cleanliness of the dishwasher appliance is improved. Further, frictional forces between the guide block and the bracket and frictional forces between the positioning shaft and the guide wheel, function to assist the elastic element in opposing the force of gravity and thereby defining the intermediate state of the hinge. As such, the longevity of the elastic element over time is improved, which may increase the useful life of the hinge and the dishwasher appliance. Additionally, by providing the elastic retainer that has a bias that acts in opposition to the bias of the elastic element, the tendency of the door to spring-back upon initially entering the intermediate state is reduced. Specifically, the elastic retainer can advantageously engage the connecting rod when the elastic element causes the hinge arm and the door to rotate towards the bracket, thereby reducing the risk that the elastic element causes the door to seal the washing chamber when the drying functionality is desired.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a side perspective view of a hinge in a closed state;

FIG. 2 is a side elevational view of the hinge in the closed state;

FIG. 3 is a side perspective view of the hinge in an open state;

FIG. 4 is a side elevational view of the hinge in the open state; and

FIG. 5 is a side perspective view of a connecting rod of the hinge.

The components in the figures are not necessarily to scale, emphasis instead being placed upon illustrating the principles described herein.

### DETAILED DESCRIPTION

The present illustrated embodiments reside primarily in combinations of method steps and apparatus components related to a hinge for a dishwasher appliance, wherein the hinge is operable to define an intermediate state to provide the dishwasher appliance with a drying functionality. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

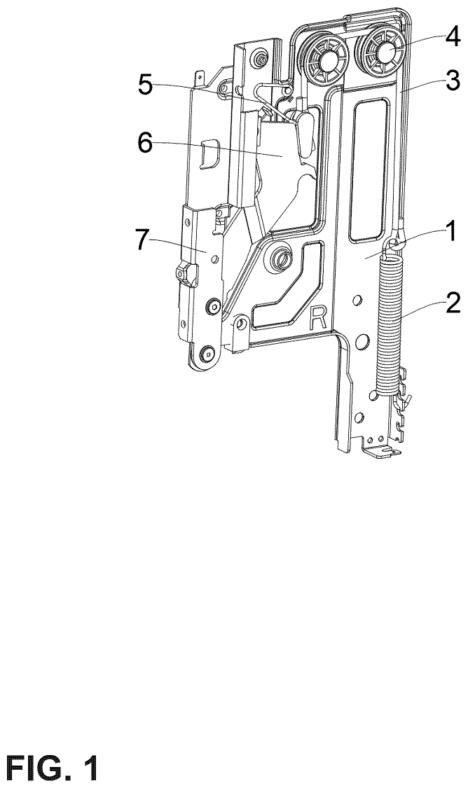

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a.” does not, without more constraints, preclude the existence of additional identical elements in the process, method, article, or apparatus that comprises the element.

With reference to FIGS. 1-5, a hinge includes a bracket 1, a hinge arm 7, a connecting rod 6, a spring-loaded assembly, and an elastic retainer 5. The hinge arm 7 includes a second rotating part 72 and a first rotating part 71, and the hinge arm 7 is hinged to the bracket 1 through the first rotating part 71. The connecting rod 6 includes a connecting rod body 61 and a guide block 65. The connecting rod body 61 is hinged to the hinge arm 7 through the second rotating part 72, and the guide block 65 is rotatably connected to the connecting rod body 61 and slidably disposed along an inner wall of the bracket 1. An end of the spring-loaded assembly is connected to the bracket 1, and another end of the spring-loaded assembly is connected to the connecting rod body 61. The elastic retainer 5 is connected to the bracket 1 and may abut against the connecting rod body 61 to restrict the movement of the connecting rod body 61 relative to the bracket 1.

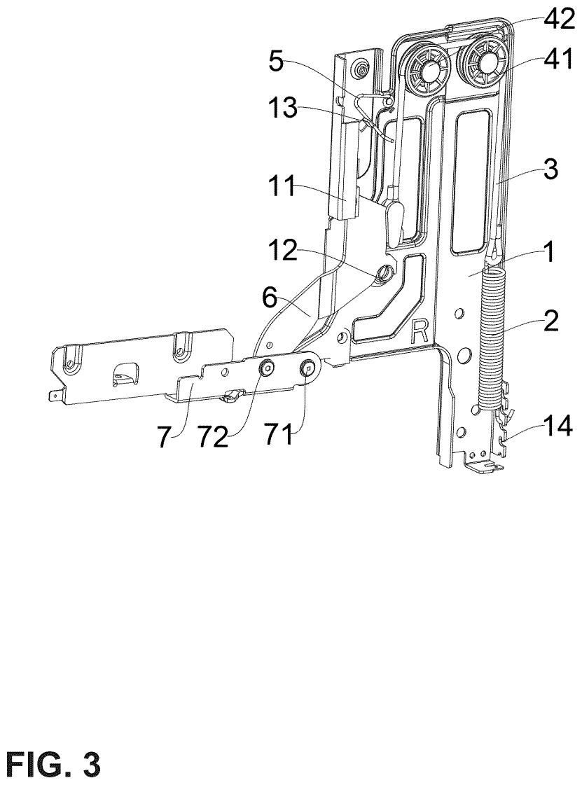

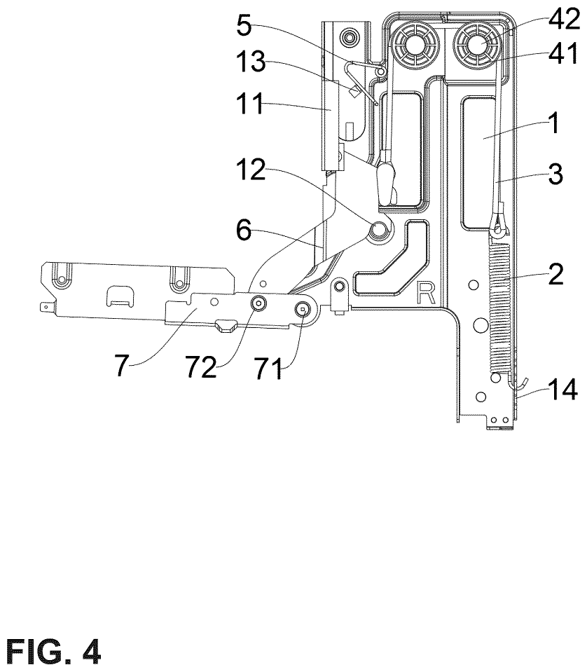

As shown in FIGS. 3 and 4, the hinge arm 7 is rotatably connected to the bracket 1 via the first rotating part 71. The hinge arm 7 is connected to and drives the connecting rod 6 to move substantially in sync with a movement of the hinge arm 7 via the second rotating part 72. The first rotating part 71 is located at an end of the hinge arm 7, and the second rotating part 72 is positioned adjacent to the first rotating part 71. The first rotating part 71 and the second rotating part 72 may be mounting holes formed by the hinge arm 7. The first rotating part 71 and the second rotating part 72 may be utilized to rotatably connect the bracket 1 and the connecting rod 6 using fasteners, such as pins, that may be disposed respectively through the first and second rotating parts 71, 72. The connections between the hinge arm 7, the bracket 1, and the connecting rod 6 may allow the hinge arm 7, the bracket 1, and the connecting rod 6 to function as a synchronous linkage mechanism. Consequently, during a closing process of the hinge, the hinge arm 7 springs back, as the connecting rod 6 is able to exert a pull force against the hinge arm 7. As the connecting rod 6 rotates synchronously about the second rotating part 72, the guide block 65 slides along the bracket 1, thereby limiting movement of the connecting rod 6 to a fixed trajectory. As the hinge transitions from an open state towards a closed state, the elastic retainer 5 abuts against the connecting rod 6 and prevents the hinge arm 7 from closing with the bracket 1, thereby defining an intermediate state of the hinge. Consequently, the hinge arm 7 and the bracket 1 maintain a space therebetween, ensuring that the hinge arm 7 remains balanced.

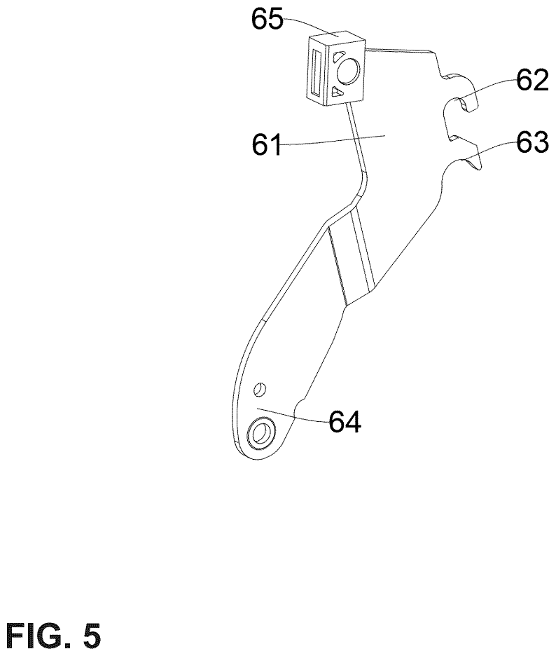

As shown in FIG. 5, the guide block 65 has an oil reservoir configured to hold a lubricant, such as grease. When the hinge arm 7 is closed with the bracket 1, the connecting rod body 61 rotates relative to the guide block 65, and oil flows out of the oil reservoir of the guide block 65. The oil lubricates the guide block 65 and the bracket 1, reducing the degree to which friction between the guide block 65 and the bracket 1 increases over time, which may otherwise increase the amount of force necessary to operate the hinge arm 7, and thus the hinge. The guide block 65 can hold liquid lubricating oil, preferably solid grease, which may extend its service life. When the connecting rod 6 rotates, the connecting rod 6 squeezes the solid grease, causing the solid grease to coat an area between the guide block 65 and the bracket 1, thereby reducing the effects of friction between the guide block 65 and the bracket 1.

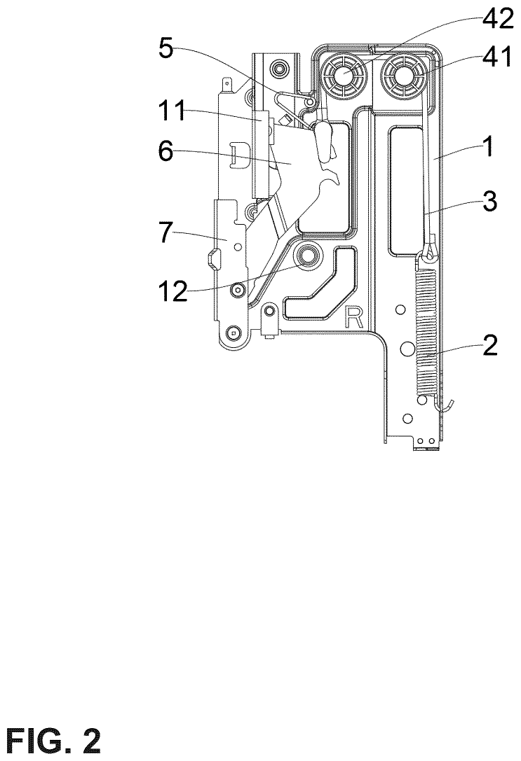

With reference now to FIGS. 1 and 2, the spring-loaded assembly includes an elastic element 2, a flexible member 3, and one or more guide members 4 disposed on the bracket 1. An end of the elastic element 2 is connected to the bracket 1, and another end of the elastic element 2 is connected to the flexible member 3. The flexible member 3 functions to connect the elastic element 2 and the connecting rod 6. The flexible member 3 rests on at least one of the guide members 4. In the configuration of the hinge illustrated in FIGS. 1-4, two guide members 4 are provided to the bracket 1.

With continued reference to FIGS. 1 and 2, the flexible member 3 is configured to exert a pulling force to the end of the connecting rod 6 to which the flexible member 3 is connected. The flexible member 3 may be connected to the connecting rod 6 via a rivet, a clamping operation, and/or a hanging operation. The elastic element 2 biases the connecting rod 6 via the flexible member 3 towards the elastic retainer 5, such that the hinge arm 7 is biased towards the bracket 1. Through this configuration, the hinge is biased towards the closed state. In combination, the bias of the elastic element 2, the frictional forces between the guide block 65 and the bracket 1, and the force of gravity acting on the hinge arm 7, function to, at least partially, balance the hinge arm 7, thereby effectuating the intermediate state of the hinge. Specifically, as the hinge arm 7 closes, the bias of the elastic element 2 in combination with the frictional forces between the guide block 65 and the bracket 1, may be substantially equal to the force of gravity acting on the hinge arm 7. Accordingly, the hinge arm 7 is suspended in a partially open state relative to the bracket 1, thereby providing the intermediate state of the hinge and improving the use of the appliance to which the hinge is installed. In the event the elastic element 2 is degraded over time, the frictional forces between the guide block 65 and the bracket 1 may compensate for the fatigue wear of the elastic element 2, thereby reducing the risk that the operation of the hinge is impaired.

With continued reference to FIGS. 1 and 2, the spring-loaded assembly includes the two guide members 4 spaced apart, wherein at least a portion of the flexible member 3 is sequentially wound around the two guide members 4. In order to improve cooperation with the flexible member 3, the two guide members 4 may be positioned at substantially the same vertical position of the bracket 1, such that a vertical distance between the two guide members 4 may be less than approximately 1 cm.

In some configurations, the guide member 4 may be a rib disposed on the bracket 1, thus allowing the flexible member 3 to fit against the rib and play a role in changing the direction of the flexible member 3. When provided as a rib, the guide member 4 can provide a smooth surface and may provide a chamfer to reduce the likelihood that an end of the rib inhibits movement of the flexible member 3. When provided as a rib, the shape of the guide member 4 may be selected in accordance with a position of the flexible member 3 relative to the guide member 4.

In the configuration of the hinge illustrated in FIGS. 1-4, each of the guide members 4 may include a positioning shaft 42 and a guide wheel 41. The positioning shafts 42 are connected to a side wall of the bracket 1. The guide wheels 41 are rotatably connected to the respective positioning shaft 42, and about an outer wall of each guide wheel 41, the flexible member 3 may be wrapped. As the hinge arm 7 opens or closes, the flexible member 3 is acted upon by the guide wheel 41 of each of the guide members 4, which play a reversing role on the flexible member 3 to improve the space utilization of the hinge. Further, as the hinge arm 7 opens or closes, the guide wheels 41 rotate relative to the respective positioning shaft 42. Consequently, frictional forces produced between the guide wheels 41 and the respective positioning shafts 42 may function to assist in maintaining the above-mentioned static balance, further compensating for the fatigue wear of the elastic element 2. Lubricating oil may be applied between the guide wheels 41 and the respective positioning shafts 42 to further improve the service life of the hinge.

With continued reference to FIGS. 1 and 2, the flexible member 3 may be a rope, belt, or chain. When the flexible member 3 is a rope, the guide wheels 41 may each be a pulley, so that the pullies and the rope cooperate. Further, when the flexible member 3 is a rope, the two ends of the flexible member 3 are both sleeved and fixed to the connecting rod 6 and the elastic element 2, respectively. When the flexible member 3 is a rope, a portion of the flexible member 3 between the two ends is sleeved and may be in contact with a groove on an outer wall of each respective pulley, so as to realize the pulling of the connecting rod 6 by the elastic element 2. When the flexible member 3 is a belt, the guide wheels 41 may each be a pulley. When the flexible member 3 is a chain, the guide wheels 41 may each be a sprocket.

As shown in FIGS. 3 and 4, the side wall of the bracket 1 has a guide strip 11 that protrudes from the bracket 1. In operation, as the hinge arm 7 rotates around the first rotating part 71, the guide block 65 slides through the guide strip 11, causing grease to flow out of an oil storage groove of the guide block 65. The guide strip 11 may be integrally formed by the bracket 1. In the configuration of the guide strip 11 illustrated in FIGS. 1-4, the cross-section of the guide strip 11 is L-shaped, so that the guide block 65 slides through and along a trajectory of the guide strip 11. When the guide block 65 slides along the guide strip 11, the solid grease is squeezed, causing the grease to coat an inner wall of the guide strip 11. As such, friction between the guide block 65 and the guide strip 11 may be reduced.

With reference now to FIGS. 4 and 5, the connecting rod body 61 includes a mounting part 62 and a limiting part 63. The mounting part 62 is connected to an end of the flexible member 3. A connecting part 64 is provided adjacent to an edge of the connecting rod body 61. The connecting part 64 is rotatably connected to the first rotating part 71 via the second rotating part 72. The mounting part 62 is rotatably attached to an end of the flexible member 3. A limiting block 12 is provided on the side wall of the bracket 1. When the hinge arm 7 opens from the bracket 1, the limiting part 63 abuts against the limiting block 12 to assist in defining the open state of the hinge. In the configuration of the hinge illustrated in FIGS. 1-5, the mounting part 62 is suspended and fixed to the flexible member 3. Particularly, one end of the flexible member 3 is sleeved on the mounting part 62, and the mounting part 62 is hook-shaped to hook the end of the flexible member 3 to facilitate replacement of the flexible member 3. The end of the connecting part 64 may be connected to the first rotating part 71 by a bearing to reduce friction between the connecting part 64 and the first rotating part 71. In the configuration of the hinge illustrated in FIGS. 1-5, the limiting part 63 is hook-shaped, and as the hinge arm 7 opens, the limiting part 63 directly abuts against an outer wall of the limiting block 12 to limit the hinge arm 7 from continuing to open from the bracket 1. The shape of the limiting block 12 can be designed to be in congruence with the limiting part 63, to allow the limiting block 12 to interface with the limiting part 63.

As shown in FIGS. 3 and 4, the bracket 1 has at least one hanging hole 14 to allow for the connection of the elastic element 2 to the bracket 1. When multiple hanging holes 14 are formed by the bracket 1, the multiple hanging holes 14 are spaced apart in a vertical direction of the bracket 1. The end of the elastic element 2 can be selectively hooked with one of the multiple hanging holes 14. A strength of the bias of the elastic element 2 varies depending on which of the multiple hanging holes 14 the elastic element 2 is connected to. Accordingly, the hanging hole 14 to which the elastic element 2 is connected may be selected according to the desired strength of the bias of the elastic element 2. As such, a user/assembler of the hinge can ensure that the bias of the elastic element 2, in combination with the frictional forces between the guide block 65 and the bracket 1, are substantially equivalent to the force of gravity acting on the hinge arm 7 to allow the hinge to define the intermediate state.

The elastic element 2 may be formed of an elastic rubber product, such as an elastic fabric. In the configuration of the elastic element 2 illustrated in FIGS. 1-4, the elastic element 2 is a spring. The resilient properties of the elastic element 2 may function to improve the service life of the hinge.

With reference to FIGS. 1-4, the inner wall of the bracket 1 is connected to the elastic retainer 5. As the hinge arm 7 is closed with the bracket 1, the elastic retainer 5 acts on the connecting rod 6 in opposition to the bias of the elastic element 2. To further define the intermediate state of the hinge, the connecting rod 6 may engage against the elastic retainer 5, specifically, press against the elastic retainer 5, causing the elastic retainer 5 to deform and thereby exert a force upon the connecting rod 6 that functions to inhibit the connecting rod 6 from closing with the bracket 1. Specifically, the force exerted by the elastic retainer 5 against the connecting rod 6 is sufficient to overcome the bias of the elastic element 2. Consequently, the elastic retainer 5 may function to further assist the hinge arm 7 in defining the intermediate stage of the hinge. When the elastic retainer 5 is not in contact with the connecting rod 6, the elastic retainer 5 remains substantially undeformed.

In the configuration of the hinge illustrated in FIGS. 1-4, the elastic retainer 5 is a torsion spring, and has a fixed end and a rotating arm. The fixed end of the elastic retainer 5 is connected to the bracket 1. Additionally, the inner wall of the bracket 1 has a stop 13 that functions to restrict movement of the rotating arm of the elastic retainer 5. The fixed end of the elastic retainer 5 may be fixed to the inner wall of the bracket 1 by rivets or screws, amongst other suitable fasteners and connective structures. The rotating arm of the elastic retainer 5 is positioned adjacent to the stop 13. When the connecting rod 6 is disengaged from the elastic retainer 5, the rotating arm of the elastic retainer 5 may engage the stop 13. When the connecting rod 6 engages the rotating arm of the elastic retainer 5, the elastic retainer 5 applies a force to the connecting rod 6 that ultimately functions to inhibit the movement of the hinge arm 7 towards the bracket 1, thereby further defining the intermediate state of the hinge.

In an additional configuration of the hinge, the elastic retainer 5 may be an elastic sheet that functions substantially identical to the torsion spring described above. Additionally, the elastic retainer 5 may be a spring and slider, wherein one end of the slider abuts against the stop 13, while the other end of the slider is suspended, so that the connecting rod 6 may abut against the slider. As shown in FIGS. 1-5, the stop 13 may be integrally formed by the bracket 1.

The hinge may be installed onto a dishwasher that includes a dishwasher body and a door. The dishwasher body has a washing chamber. The dishwasher body is connected to the bracket 1, and the door is connected to the hinge arm 7. A hinge may be provided to both sides, respectively, of the dishwasher, such that both hinges participate in the opening and closing of the door. To provide the dishwasher with a drying function, the bias of the elastic element 2, the frictional forces between the guide block 65 and the bracket 1; the weight of the hinge arm 7, and the weight of the door act in combination to balance the hinge arm 7 to achieve the intermediate state of the hinge, allowing the hinge arm 7, and therefore the door, to be suspended in a partially open state relative to the dishwasher body, to facilitate drying of contents of the dishwasher. Particularly, when the dishwasher finishes a cycle and an automatic door-opening drying function is activated, the hinge achieves the intermediate state and the door is opened to a fixed angle to facilitate drying of the contents of the dishwasher. At this time, one end of the elastic retainer 5 presses against the connecting rod 6. As the hinge enters the intermediate state, the door has a tendency to spring back towards the dishwasher body. The severity of the effects of the spring back motion may be dampened by the action of the elastic retainer 5. Specifically, the elastic retainer 5 may be engaged by the connecting rod 6, as described above, such that the movement of the connecting rod 6 is limited. Accordingly, the elastic retainer 5 functions, at least in part, to reduce the spring back motion of the door, thereby facilitating the drying function of the dishwasher.

Additionally, the hinge described above may also be used in various household appliances other than a dishwasher appliance, such as, but not limited to, an oven appliance, a microwave oven appliance, and a steam oven appliance.

The device disclosed herein is further summarized in the following paragraphs and is further characterized by combinations of any and all of the various aspects described therein.

According to one aspect of the present disclosure, a hinge for a dishwasher appliance includes, a bracket, a hinge rotatably coupled to the bracket, a connecting rod rotatably coupled to the hinge arm, an elastic retainer coupled to the bracket and selectively engaged with the connecting rod, and an elastic element coupled to the bracket and coupled via a flexible member to the connecting rod, wherein the elastic element biases the hinge arm towards the bracket, and when the connecting rod is engaged with the elastic retainer, the elastic retainer biases the hinge arm against the bias of the elastic element away from the bracket.

According to another aspect, the connecting rod is interfaced with the bracket such that the connecting rod slides relative to the bracket as the hinge arm rotates relative to the bracket.

According to another aspect, the connecting rod includes a connecting rod body and a guide block rotatably coupled to the connecting rod body, wherein the flexible member is coupled to the connecting rod via the connecting rod body and the guide block interfaces with the bracket to limit the movement of the connecting rod relative to the bracket.

According to another aspect, the bracket includes a guide strip that extends from the bracket and that defines an L-shaped cross-section, wherein the guide block is at least partially disposed within the guide strip to traverse a trajectory of the guide strip during an operation of the hinge.

According to another aspect, the guide block includes an oil reservoir configured to hold grease, wherein the oil reservoir is configured to release grease as the guide block traverses along the guide strip.

According to another aspect, the connecting rod includes a mounting part that extends outwards from a connecting rod body of the connecting rod, and a limiting part positioned adjacent to the mounting part and that extends outwards from the connecting rod body, wherein the flexible member is coupled to the connecting rod via the mounting part and the limiting part forms a hook-like shape.

According to another aspect, the bracket includes a limiting block that extends outwards from the bracket and that is configured to contact the limiting part of the connecting rod to limit the movement of the connecting rod relative to the bracket during an operation of the hinge.

According to another aspect, the hinge further includes a first guide member coupled to and extending outwards from the bracket, wherein the flexible member is, at least partially, wound about an outer wall of the first guide member.

According to another aspect, the hinge further includes a second guide member coupled to and extending outwards from the bracket, wherein the flexible member is, at least partially, wound about an outer wall of the second guide member, and wherein the second guide member is located adjacent to the first guide member.

According to another aspect, the first guide member and the second guide member are positioned at the same vertical position upon the bracket.

According to another aspect, the first guide member includes a positioning shaft coupled to and extending outwards from the bracket, and a guide wheel rotatably coupled to the positioning shaft, wherein the guide wheel forms the outer wall of the first guide member and rotates during operation of the hinge.

According to another aspect, wherein during operation of the hinge, an intermediate state of the hinge is defined when frictional forces between the guide wheel and the positioning shaft in combination with the bias of the elastic element are substantially equivalent to a force of gravity acting upon the hinge arm, wherein in the intermediate state, the hinge arm is suspended in a partially open state relative to the bracket.

According to another aspect, the connecting rod is engaged with the elastic retainer when the hinge is in the intermediate state, such that the elastic retainer exerts a force against the connecting rod in opposition to the bias of the elastic element to further define the intermediate state of the hinge.

According to yet another aspect, a hinge for a dishwasher appliance includes a bracket, a hinge arm rotatably coupled to the bracket, a connecting rod rotatably coupled to the hinge arm and interfaced with the bracket, and an elastic element coupled to the bracket and coupled via a flexible member to the connecting rod, wherein the elastic element biases the hinge arm towards the bracket, wherein during operation of the hinge, a rotational movement of the hinge arm relative to the bracket causes the connecting rod to slide through a guide strip that extends outwards from the bracket and that defines a trajectory about which movement of the connecting rod is limited.

According to another aspect, the hinge further includes an elastic retainer coupled to the bracket and configured to selectively engage the connecting rod and exert a force in opposition to the bias of the elastic element against the connecting rod to define an intermediate state of the hinge.

According to another aspect, the hinge further includes a guide member coupled to and extending outwards from the bracket, wherein the guide member includes a positioning shaft coupled to and extending outwards from the bracket and a guide wheel rotatably coupled to the positioning shaft, wherein the guide wheel forms an outer wall about which, at least a portion, of the flexible member is wound, and wherein the guide wheel is configured to rotate about the positioning shaft during operation of the hinge.

According to another aspect, wherein during operation of the hinge, the intermediate state of the hinge is defined when the connecting rod is engaged with the elastic retainer and the bias of the elastic element in combination with frictional forces between the positioning shaft and the guide wheel are substantially equivalent to a force of gravity acting upon the hinge arm, wherein in the intermediate state, the hinge arm is suspended in a partially open state relative to the bracket.

According to another aspect, the bracket forms a plurality of hanging holes spaced apart along a vertical direction of the bracket, wherein the strength of the bias provided by the elastic element is determined, at least in part, by a vertical position of the hanging hole of the plurality of hanging holes to which the elastic element is coupled.

According to yet another aspect, a dishwasher appliance includes a dishwasher body forming a washing chamber configured to hold dishware during an operation of the dishwasher appliance, a door connected to the dishwasher body and operable to selectively seal the washing chamber, and a hinge coupled to the dishwasher and the door, wherein the hinge includes a bracket attached to the dishwasher body, a hinge arm rotatably coupled to the bracket and attached to the door, a connecting rod rotatably coupled to the hinge arm, an elastic retainer coupled to the bracket and selectively engaged with the connecting rod, and an elastic element coupled to the bracket and coupled via a flexible member to the connecting rod, wherein a bias of the elastic element acts in opposition to both a force of gravity acting on the door and a bias of the elastic retainer to define an intermediate state of the hinge, wherein when the hinge defines the intermediate state, the hinge arm and the door are suspended in a partially open state relative to the dishwasher body, to allow for drying of the dishware disposed within the washing chamber.

According to another aspect, a rotational movement of the hinge arm relative to the bracket causes the connecting rod to slide through a guide strip that extends outwards from the bracket and that defines a trajectory about which movement of the connecting rod is limited.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

1-10. (canceled)

11. A hinge for a dishwasher appliance, comprising:
a bracket;
a hinge arm rotatably coupled to the bracket;
a connecting rod rotatably coupled to the hinge arm;
an elastic retainer coupled to the bracket and selectively engaged with the connecting rod; and
an elastic element coupled to the bracket and coupled via a flexible member to the connecting rod, wherein the elastic element biases the hinge arm towards the bracket, and when the connecting rod is engaged with the elastic retainer, the elastic retainer biases the hinge arm against the bias of the elastic element away from the bracket.

12. The hinge for a dishwasher appliance of claim 11, wherein the connecting rod is interfaced with the bracket such that the connecting rod slides relative to the bracket as the hinge arm rotates relative to the bracket.

13. The hinge for a dishwasher appliance of claim 12, wherein the connecting rod comprises:
a connecting rod body; and
a guide block rotatably coupled to the connecting rod body, wherein the flexible member is coupled to the connecting rod via the connecting rod body and the guide block interfaces with the bracket to limit the movement of the connecting rod relative to the bracket.

14. The hinge for a dishwasher appliance of claim 13, wherein the bracket comprises:
a guide strip that extends from the bracket and that defines an L-shaped cross-section, wherein the guide block is at least partially disposed within the guide strip to traverse a trajectory of the guide strip during an operation of said hinge.

15. The hinge for a dishwasher appliance of claim 14, wherein the guide block comprises:
an oil reservoir configured to hold grease, wherein the oil reservoir is configured to release grease as the guide block traverses along the guide strip.

16. The hinge for a dishwasher appliance of claim 13, wherein the connecting rod further comprises:
a mounting part that extends outwards from the connecting rod body of the connecting rod; and
a limiting part positioned adjacent to the mounting part and that extends outwards from the connecting rod body, wherein the flexible member is coupled to the connecting rod via the mounting part and the limiting part forms a hook-like shape.

17. The hinge for a dishwasher appliance of claim 16, wherein the bracket comprises:
a limiting block that extends outwards from the bracket and that is configured to contact the limiting part of the connecting rod to limit the movement of the connecting rod relative to the bracket during an operation of said hinge.

18. The hinge for a dishwasher appliance of claim 11, further comprising:
a first guide member coupled to and extending outwards from the bracket, wherein the flexible member is, at least partially, wound about an outer wall of the first guide member.

19. The hinge for a dishwasher appliance of claim 18, further comprising:
a second guide member coupled to and extending outwards from the bracket, wherein the flexible member is, at least partially, wound about an outer wall of the second guide member, and wherein the second guide member is located adjacent to the first guide member.

20. The hinge for a dishwasher appliance of claim 19, wherein the first guide member and the second guide member are positioned at the same vertical position upon the bracket.

21. The hinge for a dishwasher appliance of claim 18, wherein the first guide member comprises:
a positioning shaft coupled to and extending outwards from the bracket; and
a guide wheel rotatably coupled to the positioning shaft, wherein the guide wheel forms the outer wall of the first guide member and rotates during operation of said hinge.

22. The hinge for a dishwasher appliance of claim 21, wherein during operation of said hinge, an intermediate state of said hinge is defined when frictional forces between the guide wheel and the positioning shaft in combination with the bias of the elastic element are substantially equivalent to a force of gravity acting upon the hinge arm, wherein in the intermediate state, the hinge arm is suspended in a partially open state relative to the bracket.

23. The hinge for a dishwasher appliance of claim 22, wherein the connecting rod is engaged with the elastic retainer when said hinge is in the intermediate state, such that the elastic retainer exerts a force against the connecting rod in opposition to the bias of the elastic element to further define the intermediate state of said hinge.

24. A hinge for a dishwasher appliance, comprising:
a bracket;
a hinge arm rotatably coupled to the bracket;
a connecting rod rotatably coupled to the hinge arm and interfaced with the bracket; and
an elastic element coupled to the bracket and coupled via a flexible member to the connecting rod, wherein the elastic element biases the hinge arm towards the bracket, wherein during operation of said hinge, a rotational movement of the hinge arm relative to the bracket causes the connecting rod to slide through a guide strip that extends outwards from the bracket and that defines a trajectory about which movement of the connecting rod is limited.

25. The hinge for a dishwasher appliance of claim 24, further comprising:
an elastic retainer coupled to the bracket and configured to selectively engage the connecting rod and exert a force in opposition to the bias of the elastic element against the connecting rod to define an intermediate state of said hinge.

26. The hinge for a dishwasher appliance of claim 25, further comprising:
a guide member coupled to and extending outwards from the bracket, comprising:
a positioning shaft coupled to and extending outwards from the bracket; and
a guide wheel rotatably coupled to the positioning shaft, wherein the guide wheel forms an outer wall about which, at least a portion, of the flexible member is wound, and wherein the guide wheel is configured to rotate about the positioning shaft during operation of said hinge.

27. The hinge for a dishwasher appliance of claim 26, wherein during operation of said hinge, the intermediate state of said hinge is defined when the connecting rod is engaged with the elastic retainer and the bias of the elastic element in combination with frictional forces between the positioning shaft and the guide wheel are substantially equivalent to a force of gravity acting upon the hinge arm, wherein in the intermediate state, the hinge arm is suspended in a partially open state relative to the bracket.

28. The hinge for a dishwasher appliance of claim 27, wherein the bracket forms a plurality of hanging holes spaced apart along a vertical direction of the bracket, wherein the strength of the bias provided by the elastic element is determined, at least in part, by a vertical position of the hanging hole of the plurality of hanging holes to which the elastic element is coupled.

29. A dishwasher appliance, comprising:
a dishwasher body forming a washing chamber configured to hold dishware during an operation of said dishwasher appliance;
a door connected to the dishwasher body and operable to selectively seal the washing chamber; and
a hinge coupled to the dishwasher and the door, comprising:
a bracket attached to the dishwasher body;
a hinge arm rotatably coupled to the bracket and attached to the door;
a connecting rod rotatably coupled to the hinge arm;
an elastic retainer coupled to the bracket and selectively engaged with the connecting rod; and
an elastic element coupled to the bracket and coupled via a flexible member to the connecting rod, wherein a bias of the elastic element acts in opposition to both a force of gravity acting on the door and a bias of the elastic retainer to define an intermediate state of the hinge, wherein when the hinge defines the intermediate state, the hinge arm and the door are suspended in a partially open state relative to the dishwasher body, to allow for drying of the dishware disposed within the washing chamber.

30. The dishwasher appliance of claim 29, wherein a rotational movement of the hinge arm relative to the bracket causes the connecting rod to slide through a guide strip that extends outwards from the bracket and that defines a trajectory about which movement of the connecting rod is limited.
